(19) United States
(12) Patent Application Publication
(10) Pub. No.: US 2010/0193062 A1
(43) Pub. Date: Aug. 5, 2010

(54) COMPOSITE METAL TUBING

(75) Inventor: James A. Buckley, Mequon, WI (US)

Correspondence Address: BOYLE FREDRICKSON S.C., 840 North Plankinton Avenue, MILWAUKEE, WI, 53203, US

(73) Assignee: Buckley Fence LLC, Milwaukee, WI (US)

(21) Appl. No.: 12/701,048

(22) Filed: Feb. 5, 2010

Related U.S. Application Data
(60) Provisional application No. 61/150,214, filed on Feb. 5, 2009.

(51) Int. Cl. F16L 9/14

(52) U.S. Cl. 138/114; 138/104; 138/143; 138/DIG. 11

(57) ABSTRACT

A composite tubing system is formed from an outer decorative tube along with inner reinforcing tube(s) that are progressively shorter and smaller reinforcing members having greater composite thickness and strength at the location of highest bending moment. The strength and thickness may be maximized toward the center of a beam, such as a fence rail or hand rail, that is subject to maximum bending moments at its center, or may be maximized toward one end of a cantilevered beam, such as at the base of a fence post.

### CROSS-REFERENCE TO RELATED APPLICATION

This application claims the benefit of U.S. Provisional Application Ser. No. 61/150,214, filed Feb. 5, 2009, the subject matter of which is hereby incorporated by reference in its entirety.

### BACKGROUND OF THE INVENTION

1. Field of the Invention

The invention relates to metal tubing of various shapes including round used, for example, in fences. More particularly, the invention relates to a composite metal tube internally stacked beam made of thin-walled extruded aluminum painted tube mounted over progressively shorter plain steel reinforcing tube(s) or aluminum tube(s) or other progressively shorter reinforcements of a wide variety of materials.

2. Discussion of the Related Art

A popular fence construction utilizes round steel tubing for strength in keeping farm animals within a pasture. This steel tube fencing was traditionally welded together from cut lengths typically 6, 8, or 10 feet in length with support posts at each end of the section. This fence could not be corrosion protected until after it was welded in the field installation so painting had to be done in the field. Welded fence is very strong and stiff but suffers from corrosion due to the porous weld joints and the heaving effects of expansion and contraction over great distances with no provision for thermal growth and shrinkage cause by the daylight cycle on this rigid structure. This heaving causes cracking at the joints which accelerates corrosion and prevents paint from staying adhered. This steel fence could not be galvanized because the welding would just burn the zinc off leaving it with no corrosion resistance at the weld joints other than by painting. Painting in the field also is less effective for adherence and coverage since the product can not be cleaned adequately to allow a top quality finish as in a factory setting. The very high stiffness of the welded steel product may also cause animal injury due to impact of the animal into the fence.

Later innovations joined the fence rails to the post tubing with steel couplings that were set screwed in place thus avoiding the need for welding. This system was faster to install and less costly than welded fence and it allowed the tubing and the steel couplings to be galvanized and pre-coated in the factory for a better look and greater corrosion resistance than the welded variety or hand painted systems. Unfortunately the set screws that hold the couplings in place would bite through the paint and zinc galvanized coating of the post and rail tubing and serve as a corrosion starting site that caused premature rust issues. This system utilized set screws on the posts and the rails in great numbers. The effectiveness of adhering a powder coating over galvanized tubing and especially cast steel couplings is difficult and inconsistent over the long term even when done in a factory setting. This can result in delamination of the coating exposing the metal tubing to premature environmental corrosion. This system is also very stiff and as a result may injure animals that impact it similarly to the welded system.

The coupling problems were solved by Jim Buckley of Buckley Fence LLC by use of the mid joint connector fence construction system that protected the painted pipe rails from damage by isolating them from the couplings with rubber isolators allowing pipe expansion without building stress. Set screws were used with this system only on the posts and the contact points of the set screws were sealed from corrosion with rubber seal rings. These couplings are of cast aluminum construction and thus have good paint adherence and naturally great corrosion resistance in comparison to the steel couplings they replace. The problem however remained in consistently powder coating the galvanized posts and rails for long term adherence and doing so at reasonable cost. The inconsistency in coating the zinc galvanized surfaces is due to the complex chemistry of the oxidation and carbonization of the zinc coating prior to painting and the complex cleaning and pre-treatment that is necessary to paint the surfaces to assure excellent adherence under these varying conditions. These issues cause inconsistent coating adherence of the steel galvanized tubes.

What is needed is a tubular rail and post that has great paint adherence, excellent corrosion resistance, excellent strength and less stiffness for animal safety while being lower in cost.

### SUMMARY OF THE INVENTION

The inventor realized that in use as a fence product, the rails and posts are subjected to bending stresses as both simple beams (the rails) and cantilever beams (the posts). It would be possible to make both the posts and the rails out of aluminum tubing to get consistent and excellent paint adherence and natural corrosion protection. Due to the relative cost of thick walled aluminum extruded tubing versus the galvanized steel tubing and the fact that even at this greater cost the strength was too low and the deflection in the components under load was too high at three times that of the steel for the same tubing wall thickness and this amount of flexibility may be unacceptable for some applications. The inventor realized that the higher stiffness than aluminum alone and the strength of steel were desired in this application as well as the outstanding corrosion resistance and consistent and excellent paint adherence of the aluminum product. In order to achieve competitive economics in such a composite system it would be desirable to provide the beam in the form of a tubing assembly having a very thin aluminum tube over a very stiff and strong reinforcing steel tube or a set of progressively shorter tubes or other reinforcing members in steel or aluminum. In studying the loading and deflection characteristics of the rail, it became apparent that the deflection in the component was due primarily to a bending moment applied to a simply supported beam with end supports. Since the bending moment loading of the rail is triangular in profile, with a maximum bending moment at the beam center and zero bending on the supported ends, it causes very high deflections and stresses in the middle of the beam and a decreasing moment and therefore stress and deflection toward the ends of the beam where the bending stress is zero and the shear stress in negligible. It was imagined that it would be possible to reinforce just the tabular beam center section and not all the way out to the ends while achieving the simultaneous goals of ideal stiffness, high strength and low cost as well as great paint adherence and corrosion resistance. With this realization it was found that the expense of the steel tubing could be reduced by two thirds as well as its weight by more than half that of the original steel while effectively giving the composite the stiffness and strength required in the application.

This reduction can be achieved to an even greater extent by using more than one reinforcing member to progressively strengthen the tubing assembly where the bending moment is greater. This can also be achieved with multiple aluminum tubes to a similar effect and without the need for sealing or corrosion protective measures. Since the aluminum tube ends are sealed with inexpensive plastic plugs the steel would not require the expensive galvanizing operation or powder coating used on the steel only tubing rail system. In fact no corrosion protection is required at all on the steel inner member other than a light oil film.

The tubing assembly could also be formed entirely from aluminum members, in which case no measures are required for corrosion protection. This further saves cost.

With the right combination of aluminum thickness and strength as well as reinforcing member thickness, strength, stiffness and lesser length it became possible to improve the strength of the new composite rail over the all steel rail and maintain an optimum stiffness comparable with the all steel component but with more give for horse safety at less than 60% of the total weight and with more than a 20% cost savings and many times the life against corrosion.

The three tube all aluminum assembly of one embodiment reduces the weight by over 70% while attaining the strength and stiffness goals.

The reinforcing tube(s) can be centered ideally and affixed with common gluing techniques or with simple stops constructed of stamped steel, rubber or plastic. Heavily pressed plastic plugs are ideal for holding the insert and providing a second barrier to moisture ingestion in the steel zone. In the aluminum system, the inner tubes may be simply sprung out of shape on their ends such that, upon insertion into the outer tube, they form a very stiff press fit to the outer adjacent member so as to stay located in place once inserted. This system has no end caps or other extra parts other than the tubes themselves and, therefore, is very cost effective.

### BRIEF DESCRIPTION OF THE DRAWINGS

Preferred exemplary embodiments of the invention are illustrated in the accompanying drawings, in which like reference numerals represent like parts throughout, and in which:

FIGS. 1 and 1A show a composite metal tubing assembly constructed in accordance with a first exemplary embodiment of the invention and usable as a fence rail;

FIG. 1B is a sectional end view of an alternative tubing assembly taking the form of a round, three tube all aluminum assembly;

FIGS. 1C and 1D show another alternative tubing assembly in the form of an outer steel rectangular rail tube reinforced by two roll formed reinforcing members;

FIG. 2A is a cut away perspective view of an intermediate portion of the fence rail located at a transition between a reinforced and unreinforced sections of the rail of FIGS. 1 and 1A;

FIG. 2B is a sectional view taken through a reinforced section of the rail of FIGS. 1 and 1A;

FIG. 2C is a section view taken through a reinforces section of the three tube round rail of FIG. 1B;

FIG. 3 is a cut away perspective view of an end portion of the rail of FIG. 1;

FIGS. 4A-4D are various views of a retainer illustrated in FIGS. 1A and 2;

FIGS. 5A-5D are various views of a plug illustrated in FIGS. 1A and 3;

FIG. 6 schematically shows a composite metal tube constructed in accordance with a second exemplary embodiment of the invention and usable as a fence post; and

FIG. 7 is a cut away perspective view of an intermediate portion of the fence rail located at a transition between a reinforced and unreinforced sections of the post of FIG. 6.

### DETAILED DESCRIPTION OF THE PREFERRED EMBODIMENTS

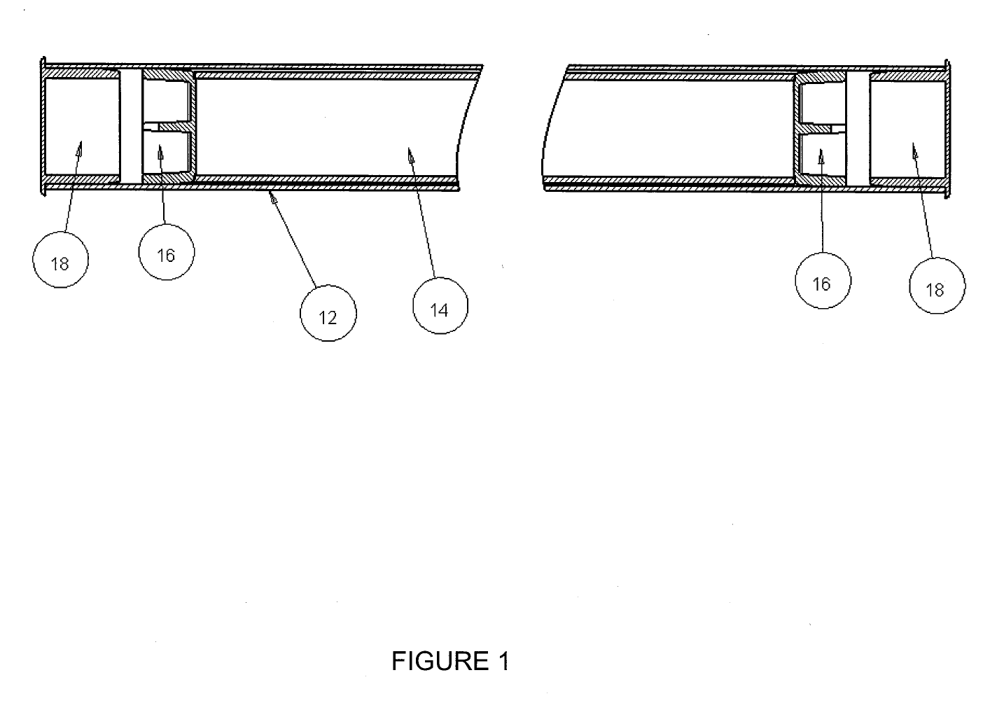

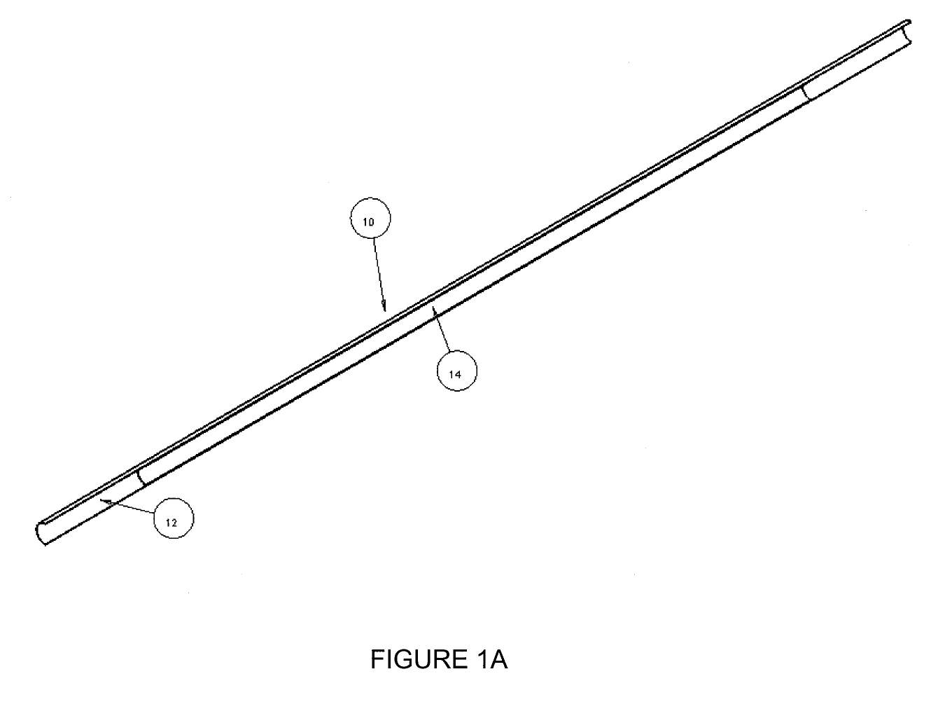

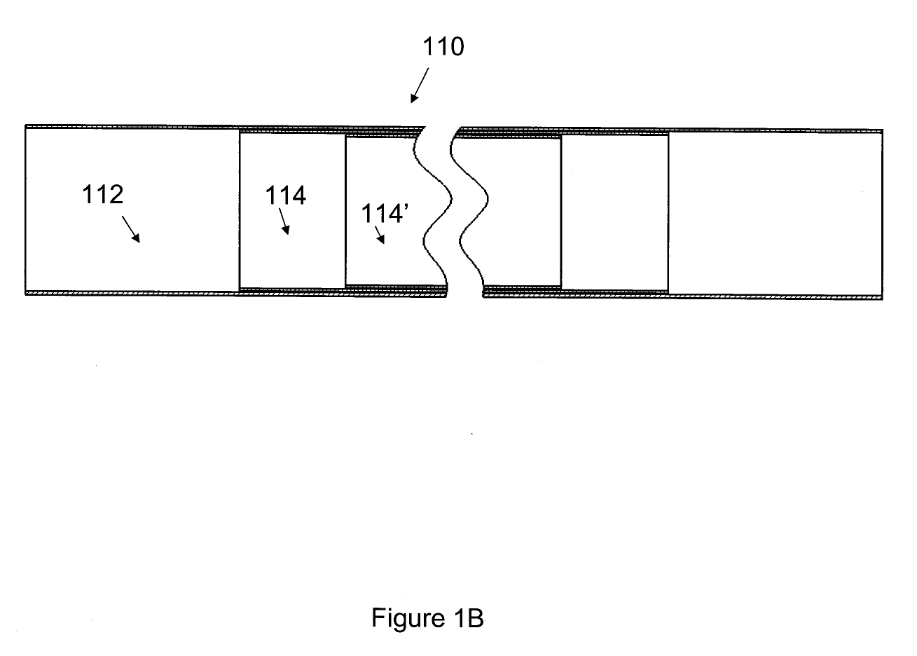

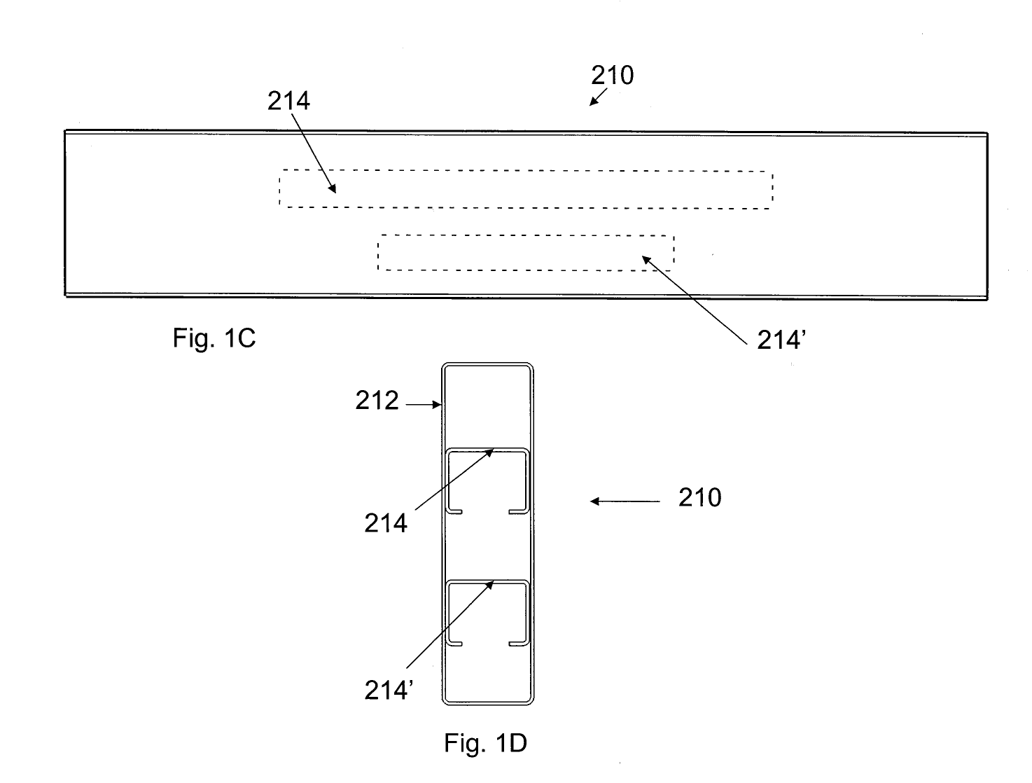

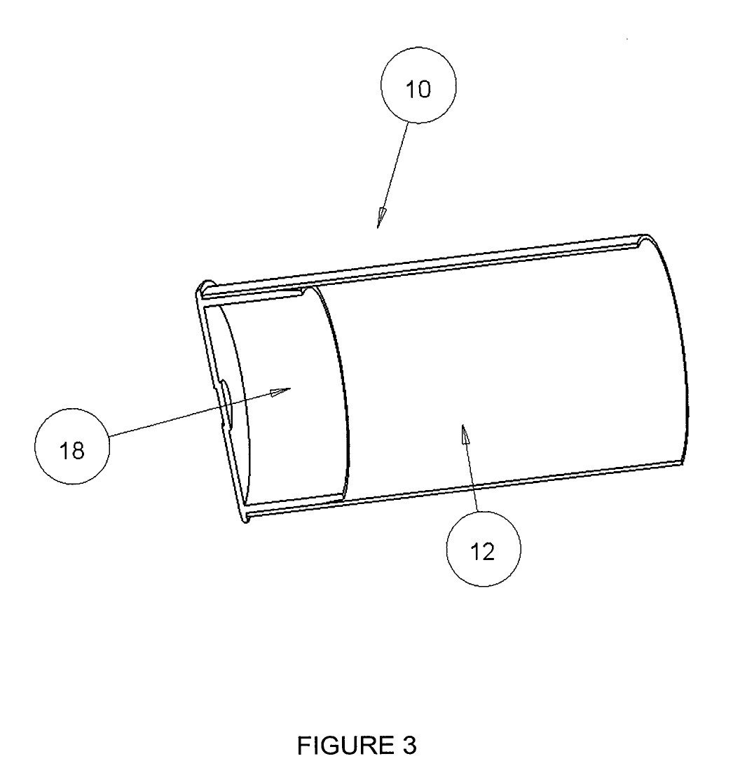

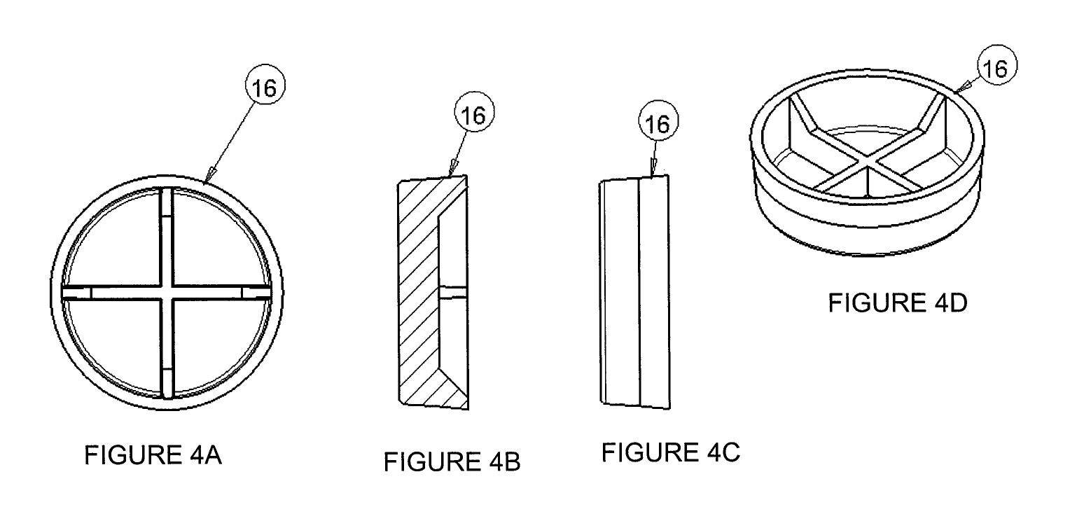

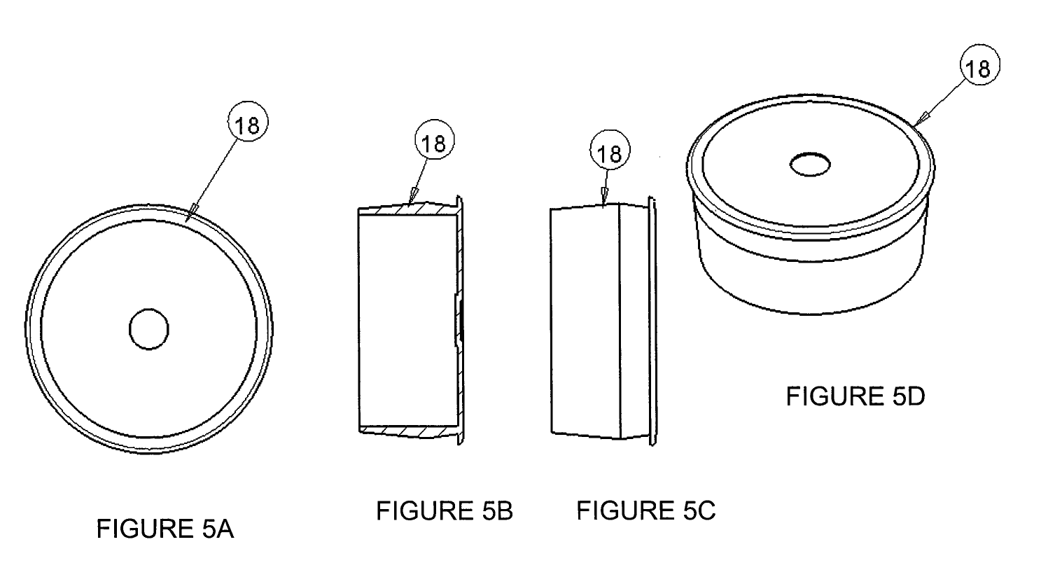

Typical embodiments of composite tubing assemblies 10, 110, 210 constructed in accordance with the invention, is as shown in FIGS. 1-5.

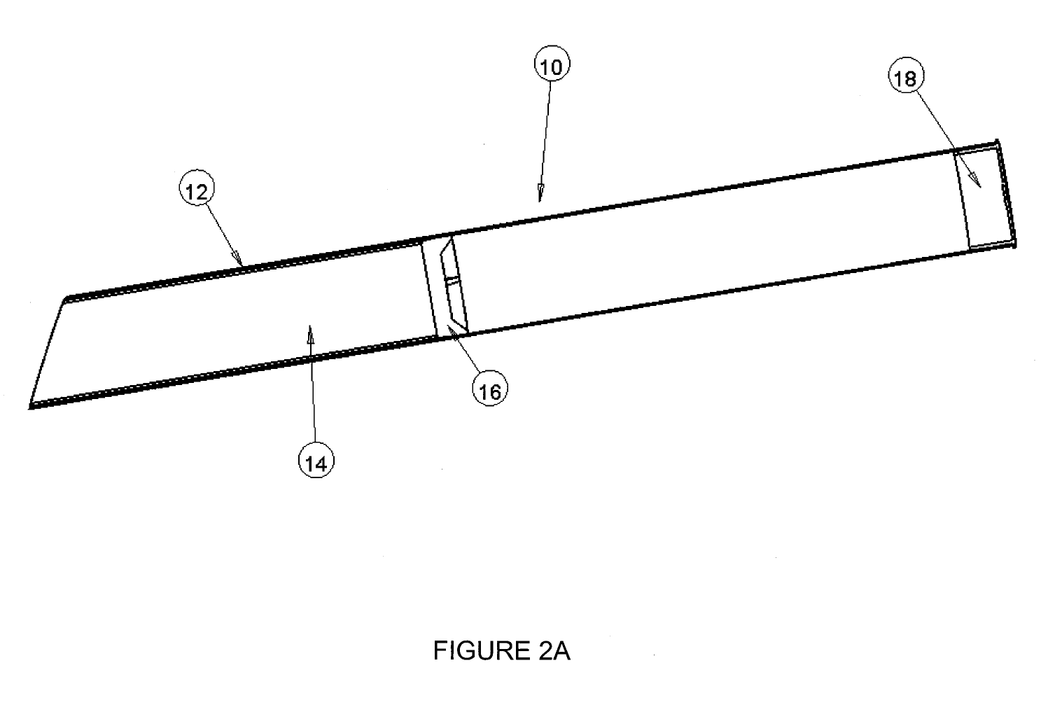

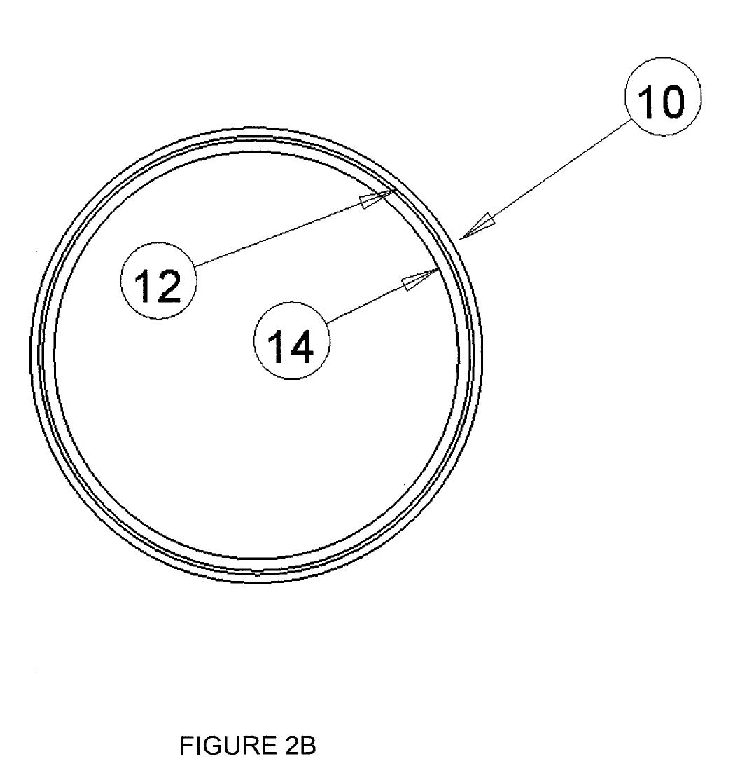

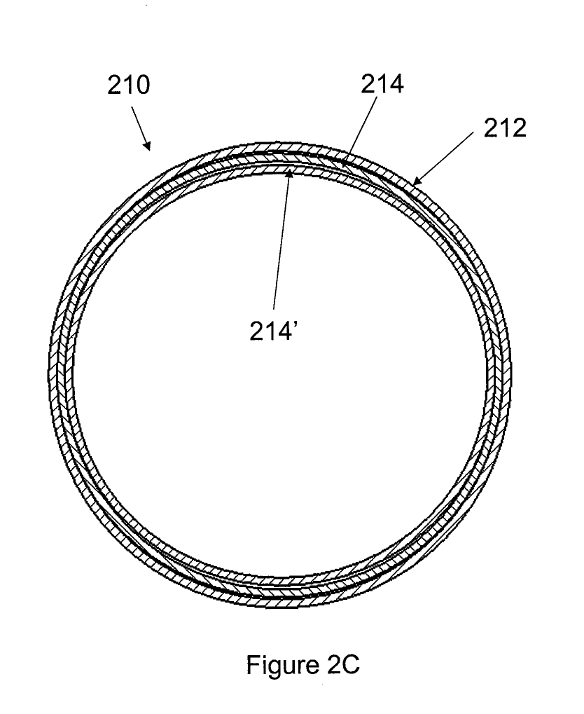

Turing first to FIGS. 1, 1A, 2, and 2A, tube assembly 10 is designed for use as a fence rail, but the same or other tubes constructed in accordance with the invention could be used for other applications as well, such as hand rails. The assembly 10 is composed of a thin walled (approximately 1 mm) powder coated aluminum tube 12 mounted over an uncoated heavier walled (approximately 1.5 mm) steel reinforcing tube 14 that spans typically half to two thirds the rail length and is centered and fixed in the aluminum tube with plugs or other devices. A retainer plug 16 is positioned outside of each end of the steel tube 14 to prevent axial movement of the steel tube 14 within the aluminum tube 12. A cap 18 is inserted into each end of the aluminum tube 12 to protect the steel tube 12 from moisture and therefore corrosion.

An alternative tubing assembly 110 is shown in FIGS. 1B and 2C with an outer thin walled (approximately 1 mm) tube 112 of powder coated aluminum with two inner aluminum reinforcing tubes 114, 114′ of a similar thickness but without any secondary coatings required. The intermediate tube 114 runs about 60% of the length of the outer tube 112 while the inner tube 114′ runs less than 25% of the outer tube length. As seen in FIG. 2C, the inner tubes 114, 114′ may be simply sprung out of shape on their ends such that, upon insertion into the outer tube 112, they form a very stiff press fit to the outer adjacent member so as to stay located in place once inserted. This system has no end caps, plugs, or other extra parts other than the tubes themselves and, therefore, is very cost effective.

The benefits of a providing a composite tube reinforced along only part of its length can be appreciated by realizing that a simply supported beam such as the fence rail supported on both ends is subject to the highest stresses at its center. Referring to the embodiment of FIGS. 1A and 1B by way of example, the reinforcing steel beam strength provided by the reinforcing tube 14 is most effective in and near this center area. The bending stress is zero at the ends of a simply supported beam, and, therefore reinforcement is not needed in or near the ends of the tube 10. As a result, for example, with a 10 foot fence rail section extruded in aluminum with supports 9.5 feet apart it is only necessary to have a steel reinforcing tube that is approximately 6 to 7 feet in length. This composite product is 45% lighter than the completely steel beam it would replace while being significantly lower in cost. It also offers many times the corrosion resistance and adheres to the paint much better than the steel product that is necessarily galvanized and is equal or greater in strength. The composite tube 10 can be at least 60% and as much as 100% or even 150% more flexible than it's all steel counterpart and is therefore safer for the animals that on occasion can impact the fence. This results in a fence rail that maintains its beauty over a much longer time span while achieving the goals of strength, stiffness, light weight, animal friendly and low cost against the all steel galvanized and powder coated product it replaces.

The three aluminum tube assembly of FIGS. 1B and 2C shows a 73% weight reduction against the all steel version while being the lowest cost alternative. This assembly has the greatest long term durability against corrosion and offers equivalent strength while giving even greater flexibility for yet greater animal safety.

In yet another variant, shown in FIGS. 1C and 1D, the tubing assembly 210 can take the form of an outermost steel tube 212 reinforced inwardly with one or more reinforcing members 214, 214′ of progressively shorter length. The outer tube 214 could be rectangular as illustrated or any other shape. The reinforcing members 214, 214′ could be formed from tubes, bars, or open roll-formed C shaped reinforcing bars as shown. The outer tube 212 preferably is formed from galvanized steel, and the inner tubes 214 and 214′ preferably are formed from raw steel.

The parameters for composite fence post construction are different in design than the fence rails, but are similar in their goals to demonstrate superior strength over the all-steel post. Replacing an all-steel post with a composite post also improves the cost effectiveness, the corrosion resistance, as well as the paint adherence.

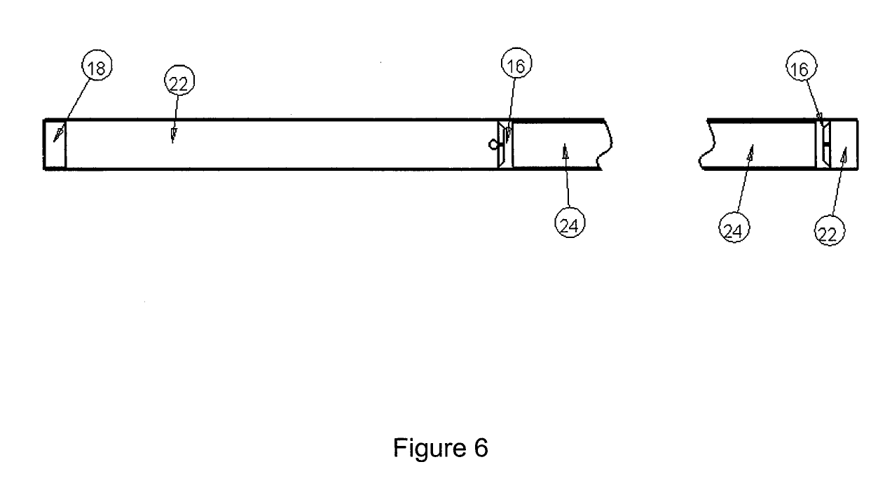

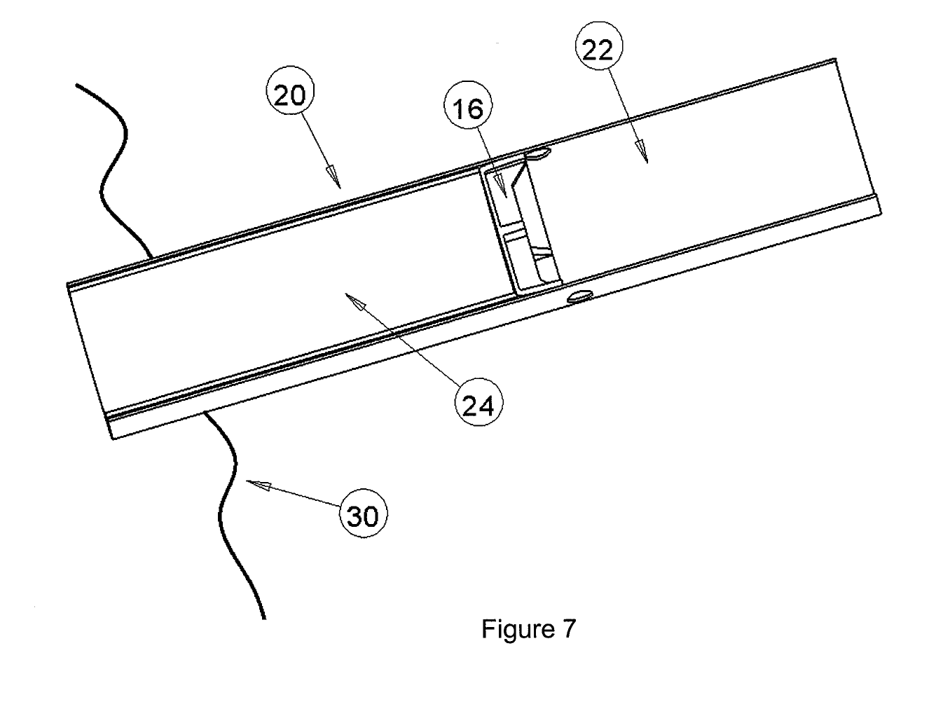

Fence posts are loaded as a cantilever beam with the base rigid in concrete and the loading well up on the vertical beam and perpendicular to it. In this case, referring to FIGS. 6 and 7, a fence post 20 formed from a composite tube includes an aluminum tube 22 which is reinforced by a steel tube 24 from near the top of the post to approximately one foot below ground level 30, while the unreinforced aluminum tube 22 extends to a three-foot imbedded depth. Plugs 16 are provided above and below the steel tube 24, and the bottom of the aluminum tube 22 is closed by a cap 18. This arrangement realizes all the goals by keeping the reinforcing steel tube 24 only in the area of the post where it contributes to increased strength, stiffness and resistance to bending by the fence couplings and the crushing forces of the set screws used in the couplings. For the posts the inner steel sleeve is typically thicker walled than the rail sleeve since the posts are the main structure of the system. The outer aluminum tubing for the posts remain at approximately 1 mm in thickness.

In post systems where there are no crushing coupling fastener forces, the inner supports can be at a significantly shorter height since the bending moment is maximum at the ground level and zero at the top of the post. Posts can similarly be made utilizing more than two elements with similar positive effects as seen in the rail application.

The cross section of the composite tubing for both fence rails and posts as well as for other applications can be of any shape in cross section. The principal is to utilize the unique capabilities of both the outer tubes and the inner tubes while conserving material to achieve the goals of corrosion resistance, paint adherence, stiffness, strength, animal safety and total cost.

Although the best mode contemplated by the inventors of carrying out the present invention is disclosed above, practice of the present invention is not limited thereto. It will be manifest that various additions, modifications, and rearrangements of the features of the present invention may be made in addition to those described above without deviating from the spirit and scope of the underlying inventive concept. The scope of some of these changes is discussed above. The scope of other changes to the described embodiments that fall within the present invention but that are not specifically discussed above will become apparent from the appended claims and other attachments.

I claim:

1. A composite tubing assembly comprising:
a decorative outer tube that is reinforced internally by at least one reinforcing member that is shorter in length and smaller in diameter than the outer tube, the tubing assembly having a greater thickness and strength at a location that is to be subject to a relatively high bending moment and a reduced thickness and strength at a location that is to be subject to a relatively low bending moment.

2. The composite tubing assembly of claim 1, wherein the tubing assembly comprises a fence post having a base and a free end, and wherein the tubing assembly has a greater thickness and strength at the base than at the free end.

3. The composite tubing assembly of claim 1, wherein the tubing assembly comprises a rail, and wherein the tubing assembly has a greater thickness and strength at a central portion thereof than at opposed ends thereof.

4. The composite tubing assembly of claim 3, wherein the tubing assembly comprises an outer aluminum tube and an inner steel reinforcing tube, and wherein the steel reinforcing tube is less than 80% of the length of the aluminum tube and is located centrally lengthwise within the aluminum tube.

5. The composite tubing assembly of claim 4, whereas the steel reinforcing tube is raw with no protective coating.

6. The composite tubing assembly of claim 4, where the aluminum tube has caps on each end to protect the steel from moisture.

7. The composite tubing assembly of claim 4, where the steel reinforcing tube is held in position with press fit plastic plugs that position and seal the steel from environmental moisture.

8. The composite tubing assembly of claim 4, wherein the steel reinforcing tube is held in position with press fit plastic plugs that position and seal the steel from environmental moisture and is double protected with a pressed-in plastic end cap on the steel tube end that also protects from corrosion as well as holds the tube end in place.

9. The composite tubing assembly of claim 1, wherein the outer tube of the tubing assembly is formed from aluminum.

10. The composite tubing assembly of claim 9, wherein the tubing assembly comprises at least three nested tubes, all of which are formed from aluminum, the inner tubes being of progressively shorter length than the outer tube.

11. The composite tubing assembly of claim 9, wherein at least one inner reinforcing member of the tube assembly is formed from steel.

12. The composite tubing assembly of claim 1, wherein the outer tube is formed from galvanized steel and the reinforcing members are formed from steel.

13. The composite tubing assembly of claim 1, wherein the outer tube is non-circular in cross section.

14. The composite tubing assembly of claim 13, wherein the outer tube is at least substantially rectangular in cross section.

15. The composite tubing assembly of claim 1, wherein the tubing assembly comprises a plurality of nested tubes of progressively shorter length from the outermost tube in, at least one inner tube of the assembly being retained in place by having at least one end thereof deformed out of its basic shape adequately to create significant press and friction against an adjacent tube

16. A cantilevered beam comprising:
a composite metal tubing assembly having a base that is subject to relatively high bending moment and a fee end that is subject to a relatively low bending moment, the composing tubing assembly comprising an outer tube that is internally reinforced by at least one reinforcing member that is shorter in length and smaller in diameter than the outer tube, the composite tubing assembly having a greater thickness and strength at the base and a reduced thickness and strength at the free end.

17. The cantilevered beam of claim 16, wherein the beam is a fence post.

18. A decorative structural metal beam of reinforced non round closed cross section that is reinforced by one or more progressively shorter metal reinforcing members that progressively strengthen the outer beam toward the beam center.

19. The structural beam of claim 18, wherein multiple reinforcing members are provided and are of various lengths and shapes to optimize strength and stiffness.

20. The structural beam of claim 18, wherein the beam is a fence rail.
